(19) United States
(12) Patent Application Publication
(10) Pub. No.: US 2010/0306422 A1
(43) Pub. Date: Dec. 2, 2010

(54) COMMUNICATION APPARATUS

(75) Inventors: Tomoko KODAMA, Kariya-shi (JP); Tomohisa KISHIGAMI, Oobu-shi (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/787,010

(22) Filed: May 25, 2010

(30) Foreign Application Priority Data
May 26, 2009 (JP) 2009-126567

(51) Int. Cl. G06F 3/00; G06F 1/10

(52) U.S. Cl. 710/30; 713/500

(57) ABSTRACT

The present invention provides, as one aspect, a communication apparatus which is connected with a communication bus and performs communication using Carrier Sense Multiple Access with Collision Avoidance (CSMA/CA). The apparatus includes an edge detection section which detects an edge of data on the communication bus, and a data obtaining section which obtains data from the communication bus to determine a collision of data on the communication bus after a predetermined delay time period has passed from the time at which the edge detection section detects the edge.

### CROSS REFERENCE TO RELATED APPLICATION

This application is based on and claims the benefit of priority from earlier Japanese Patent Application No. 2009-126567 filed May 26, 2009, the description of which is incorporated herein by reference.

### BACKGROUND OF THE INVENTION

1. Technical Field of the Invention

The present invention relates to a communication apparatus which performs communication using Carrier Sense Multiple Access with Collision Avoidance (CSMA/CA).

2. Related Art

In vehicles, a local area network (so-called in-car LAN) has been configured by interconnecting in-car devices such as an electronic control unit (ECU) via a communication bus (see Japanese Patent Laid-open Publication No. 2003-264567, for example). According to this configuration, information is shared among the in-car devices, thereby sophisticating control of the vehicle and providing satisfactory services. Note that Controller Area Network (CAN), which employs Carrier Sense Multiple Access with Collision Avoidance (CSMA/CA), has often been used as the in-car LAN.

Conventionally, in data communication using CSMA/CA, processes for obtaining data on a communication bus (hereinafter, referred to as “sampling”) differ between in the case of transmitting data and in the case of receiving data. That is, when a communication apparatus transmits data to the communication bus, the communication apparatus performs the sampling with reference to the time of transmitting the data therefrom to detect collisions between transmitted data and conduct arbitration. When the communication apparatus receives data from the communication bus, the communication apparatus performs the sampling with reference to the time of detecting an edge of data on the communication bus.

In the data communication using CSMA/CA, the timing (hereinafter, referred to as “first sampling timing”) at which a communication apparatus (hereinafter, referred to as “first communication apparatus”) performs the sampling, when the first communication apparatus transmits data, is set in consideration of the condition in which both the first communication apparatus and other communication apparatus (hereinafter, referred to as “second communication apparatus”) transmit data. Therefore, the first sampling timing is set so as to be after the delay time period during which the data transmitted from the first communication apparatus arrives at the second communication apparatus and before the timing at which the first communication apparatus completes the data transmission.

However, when the time period for one bit of communication data is shortened for high-speed data communication, the time period between the times at which the first communication apparatus starts and completes data transmission is shortened. This makes it difficult to ensure a sufficient time period, during which the sampling is possible, between the time after the delay time period and the time at which the first communication apparatus completes data transmission. Thereby, the reliability of detecting the collision can be decreased.

### SUMMARY OF THE INVENTION

The present invention has been made in consideration of the foregoing conventional situation, and an object of the present invention is to provide a communication apparatus which can provide high-speed data communication without decreasing the reliability of detecting a collision.

In order to achieve the object, the present invention provides, as one aspect, a communication apparatus which is connected with a communication bus and performs communication using Carrier Sense Multiple Access with Collision Avoidance (CSMA/CA), including: an edge detection section which detects an edge of data on the communication bus; and a data obtaining section which obtains data from the communication bus to determine a collision of data on the communication bus after a predetermined delay time period has passed from the time at which the edge detection section detects the edge.

### BRIEF DESCRIPTION OF THE DRAWINGS

In the accompanying drawings:

FIG. 1 is a block diagram showing a configuration of a CAN communication system according to an embodiment;

FIG. 2 is a flowchart showing a sampling process at the time of transmission;

FIG. 3 is a time chart showing input and output of data in CAN controllers and CAN transceivers;

FIG. 4 is a time chart showing sampling points; and

FIG. 5 is a block diagram showing a configuration of a CAN communication system according to another embodiment.

### DETAILED DESCRIPTION OF THE PREFERRED EMBODIMENTS

Hereinafter, embodiments of the present invention will now be described in connection with the accompanying drawings. In the embodiments set forth below, the components identical with or similar to each other are given the same reference numerals for the sake of omitting explanation.

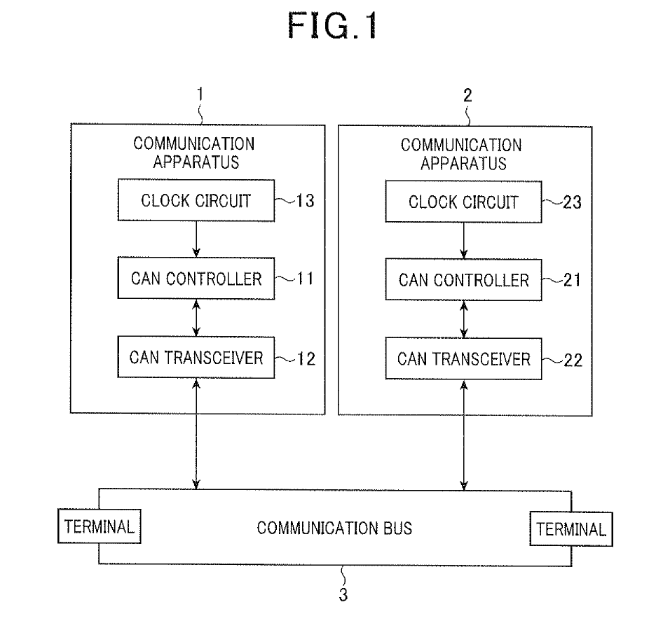

FIG. 1 is a block diagram showing a configuration of a CAN communication system.

As shown in FIG. 1, the CAN communication system of the present embodiment is configured by connecting communication apparatuses 1 and 2 with each other via a communication bus 3 so that data communication can be performed. Note that the CAN communication system employs a Controller Area Network (CAN) protocol using Carrier Sense Multiple Access with Collision Avoidance (CSMA/CA).

The communication apparatuses 1 and 2 include CAN controllers 11 and 21, CAN transceivers 12 and 22, and clock circuits 13 and 23, respectively. The CAN controllers 11 and 21 control communication between the communication apparatuses 1 and 2 and other communication apparatuses based on the CAN protocol. The CAN transceivers 12 and 22 receive transmitted data produced by the CAN controllers 11 and 21 and transmit the data to the communication bus 3. In addition, the CAN transceivers 12 and 22 output received data received from the communication bus 3 to the CAN controllers 11 and 21. The clock circuits 13 and 23 produce clock signals having a predetermined frequency and output the clock signals to the CAN controllers 11 and 21.

In the communication apparatuses 1 and 2 configured as described above, the CAN controllers 11 and 21 perform a sampling process in which data is obtained from the communication bus 3 to detect a collision between the transmitted data.

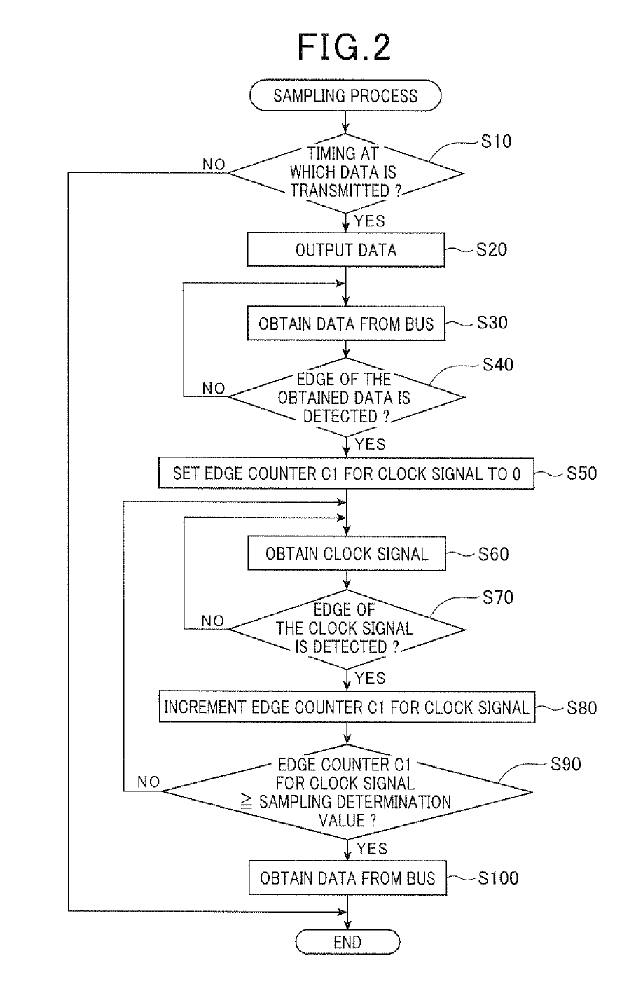

FIG. 2 is a flowchart showing the sampling process. Hereinafter, the sampling process performed by the CAN controllers 11 and 21 will be described with reference to FIG. 2. The sampling process is repeated while the communication apparatuses 1 and 2 are in operation.

On starting the sampling process, in step S10, the CAN controllers 11 and 21 determine whether or not it is the timing at which data should be transmitted to the communication bus 3. When determined that it is not the timing at which data should be transmitted (S10: NO), the sampling process is temporarily ended. When determined that it is the timing at which data should be transmitted (S10: YES), in step S20, the CAN controllers 11 and 21 output data to the CAN transceivers 12 and 22. Thereby, the CAN transceivers 12 and 22 transmit the data to the communication bus 3. Then the process proceeds to step S30.

In step S30, the CAN controllers 11 and 21 make the CAN transceivers 12 and 22 receive data from the communication bus 3. Thereby, the CAN controllers 11 and 21 obtain the data from the communication bus 3 via the CAN transceivers 12 and 22. In step S40, the CAN controllers 11 and 21 determine whether or not an edge of the obtained data is detected. That is, the CAN controllers 11 and 21 determine whether or not the obtained data has changed from high level to low level, or from low level to high level.

When the edge of the obtained data is not detected (S40: NO), the process proceeds to step S30, in which the above step is repeated. When the edge of the obtained data is detected (S40: YES), in step S50, the CAN controllers 11 and 21 set an edge counter C1, which is provided in the CAN controllers 11 and 21, to 0. In step S60, the CAN controllers 11 and 21 obtain a clock signal outputted from the clock circuits 13 and 23.

In step S70, the CAN controllers 11 and 21 determine whether or not an edge of the obtained clock signal is detected. When the edge of the obtained clock signal is not detected (S70: NO), the process proceeds to step S60, in which the step described above is repeated. When the edge of the obtained clock signal is detected (S70: YES), in step S80, the CAN controllers 11 and 21 increment the edge counter C1.

In step S90, the CAN controllers 11 and 21 determine whether or not the value of the edge counter C1 (hereinafter, referred to as “the number of detected edges”) is equal to or more than a predetermined sampling determination value (for example, 7). When the number of detected edges is less than the sampling determination value (S90: NO), the process proceeds to step S60, in which the step described above is repeated. When the number of detected edges is equal to or more than the sampling determination value (S90: YES), in step S100, the CAN controllers 11 and 21 make the CAN transceivers 12 and 22 receive data from the communication bus 3, and temporarily end the sampling process. Thereby, the CAN controllers 11 and 21 can obtain the data from the communication bus 3 via the CAN transceivers 12 and 22 to determine whether or not a collision between transmitted data has occurred.

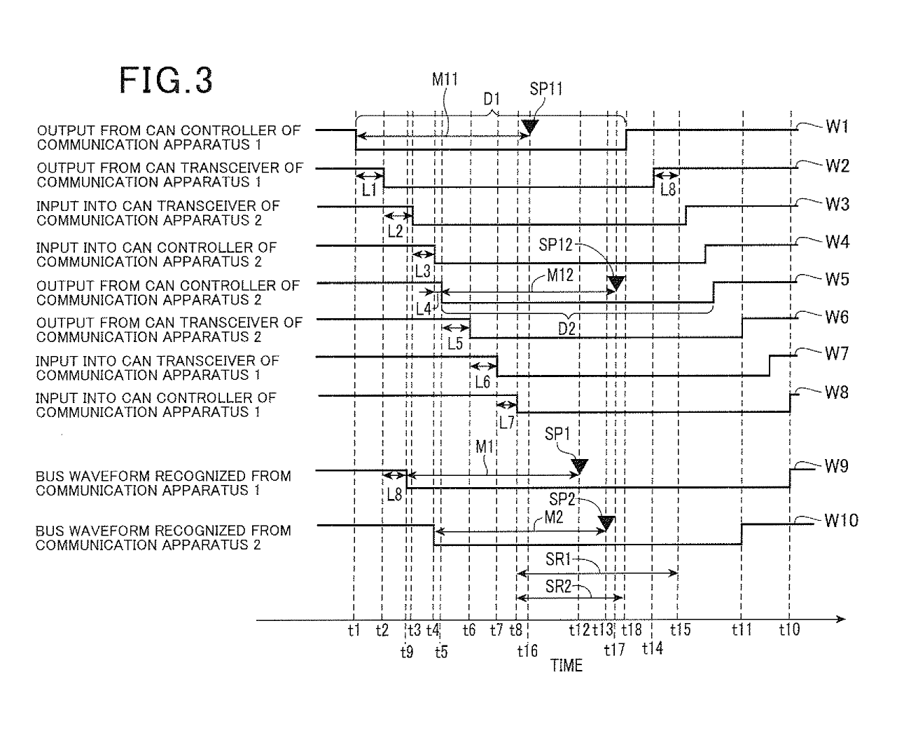

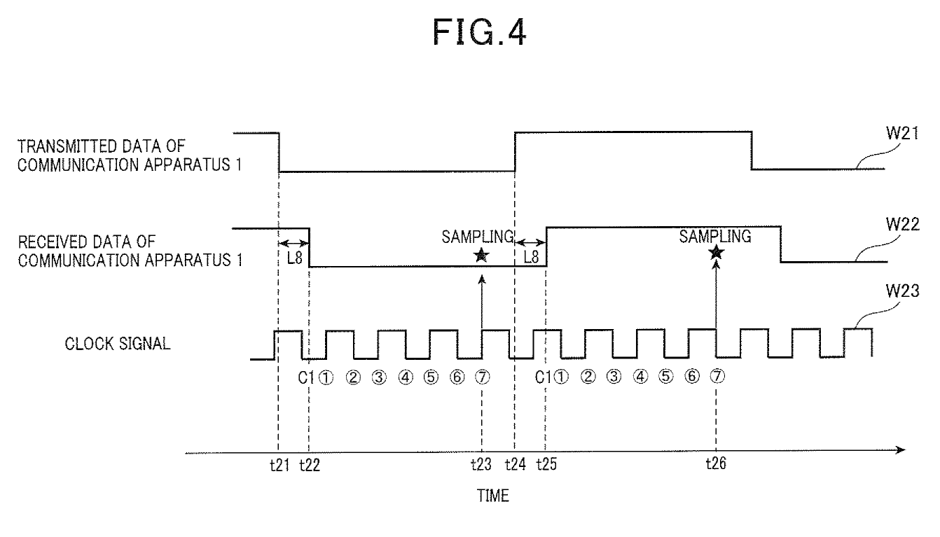

FIG. 3 is a time chart showing input and output of data in the CAN controllers 11 and 21 and the CAN transceivers 12 and 22. FIG. 4 is a time chart showing sampling points. Hereinafter, operations of the communication apparatuses 1 and 2 configured as described above will be described with reference to FIGS. 3 and 4.

In FIG. 3, the communication apparatus 1 transmits data. Then, the communication apparatus 2 transmits data immediately before the communication apparatus 2 recognizes the arrival of the data transmitted from the communication apparatus 1.

As shown in FIG. 3, when the CAN controller 11 of the communication apparatus 1 outputs one-bit data D1 (low-level data in FIG. 3) (see time t1 of output waveform W1), the CAN transceiver 12 of the communication apparatus 1 outputs the data D1 (see time t2 of output waveform W2) after a first delay time period L1 (for example, 200 ns) has passed.

Consequently, the data D1 is inputted into the CAN transceiver 22 of the communication apparatus 2 (see time t3 of input waveform W3) via the communication bus 3 after a second delay time period L2 (for example, 200 ns) has passed. Then, the data D1 is inputted into the CAN controller 21 of the communication apparatus 2 (see time t4 of input waveform W4) after a third delay time period L3 (for example, 150 ns) has passed.

Note that the CAN controller 21 of the communication apparatus 2 outputs one-bit data D2 (low-level data in FIG. 3) (see time t5 of output waveform W5) before the CAN controller 21 recognizes the input of the data D1 (i.e. after a fourth delay time period L4 (for example, 50 ns) has passed from the input of the data D1). Then the CAN transceiver 22 of the communication apparatus 2 outputs the data D2 (see time t6 of output waveform W6) after a fifth delay time period L5 (for example, 200 ns) has passed

Consequently, the data D2 is inputted into the CAN transceiver 12 of the communication apparatus 1 (see time t7 of input waveform W7) via the communication bus 3 after a sixth delay time period L6 (for example, 200 ns) has passed. Then, the data D2 is inputted into the CAN controller 11 of the communication apparatus 1 (see time t8 of input waveform W8) after a seventh delay time period L7 (for example, 150 ns) has passed.

Then, in a state where the communication apparatuses 1 and 2 operate as described above, a bus waveform W9 on the communication bus 3, which can be recognized from the communication apparatus 1, changes from high level to low level at time t9 which is delayed from time t2 by an eighth delay time period L8 (for example, 150 ns). Note that the eighth delay time period L8 is the time period which the CAN transceiver 12 requires in order to obtain the data D1 from the communication bus 3 after the CAN transceiver 12 outputs the data D1 to the communication bus 3. The bus waveform W9 changes from low level to high level at time t10 (see time t10 of input waveform W8) at which the input of the data D2 into the CAN controller 11 of the communication apparatus 1 is completed.

A bus waveform W10, which can be recognized from the communication apparatus 2, on the communication bus 3 changes from high level to low level at time t4 at which the data D1 is inputted into the CAN controller 21 of the communication apparatus 2. The bus waveform W10 changes from low level to high level at time t11 (see time t11 of output waveform W6) at which the CAN transceiver 22 of the communication apparatus 2 completes the output of the data D2.

Then, as shown in FIG. 4, after the eighth delay time period L8 has passed from the transmission of low-level data (see time t21 of transmitted data waveform W21), the communication apparatus 1 detects an edge of the received data based on the change of the received data from high level to low level (see time t22 of received data waveform W22). Thereafter, when the number of detected edges of the clock signal becomes equal to or more than the sampling determination value (for example, 7) (see time t23 of clock signal W23), the communication apparatus 1 obtains data from the communication bus 3 to detect a collision. Similarly, after the eighth delay time period L8 has passed from the transmission of high-level data (see time t24 of transmitted data waveform W21), the communication apparatus 1 detects an edge of the received data based on the change of the received data from low level to high level (see time t25 of received data waveform W22). Thereafter, when the number of detected edges of the clock signal becomes equal to or more than the sampling determination value (for example, 7) (see time t26 of clock signal W23), the communication apparatus 1 obtains data from the communication bus 3 to detect a collision.

Note that, as in the case of the communication apparatus 1, the communication apparatus 2 also obtains data from the communication bus 3 to detect a collision when the number of detected edges of the clock signal becomes equal to or more than the sampling determination value after the detection of the edge of the received data.

Hence, as shown in FIG. 3, when the communication apparatuses 1 and 2 are in operation, the communication apparatus 1 obtains data to detect a collision (hereinafter, referred to as “sampling”) at time t12 by which a sampling measurement time period M1 has passed from time t9 at which the bus waveform W9 changes from high level to low level (see sampling point SP1). The number of detected edges becomes equal to or more than the sampling determination value during the sampling measurement time period M1. The communication apparatus 2 performs the sampling at time t13 by which a sampling measurement time period M2 has passed from time t4 at which the bus waveform W10 changes from high level to low level (see sampling point SP2). The number of detected edges becomes equal to or more than the sampling determination value during the sampling measurement time period M2.

In this case, a period of time (hereinafter, referred to as “sampling possible period SR1”) during which both the communication apparatuses 1 and 2 can perform the sampling is between time t8 at which the data D2 is inputted into the CAN controller 11 of the communication apparatus 1, and time t15 which is delayed by the eighth delay time period L8 from time t14 at which the CAN transceiver 12 of the communication apparatus 1 completes the output of the data D1 (see time t14 of output waveform W2). The sampling points SP1 and SP2 are set within the sampling possible period SR1.

Conventionally, a CAN controller performs the sampling after a predetermined time has passed from the time at which the CAN controller outputs data. When this conventional method is applied to the operations of the communication apparatuses 1 and 2 as shown in FIG. 3, the communication apparatus 1 performs the sampling at time t16 by which a sampling measurement time period M11 has passed from time t1 at which the CAN controller 11 outputs the data D1 (see sampling point SP11). The number of detected edges becomes equal to or more than the sampling determination value during the sampling measurement time period M11. The communication apparatus 2 performs the sampling at time t17 by which a sampling measurement time period M12 has passed from time t5 at which the CAN controller 21 outputs the data D2 (see sampling point SP12). The number of detected edges becomes equal to or more than the sampling determination value during the sampling measurement time period M12.

In this case, a period of time (hereinafter, referred to as “sampling possible period SR2”) during which both the communication apparatuses 1 and 2 can perform the sampling is between time t8 at which the data D2 is inputted into the CAN controller 11 of the communication apparatus 1, and time t18 at which the CAN controller 11 of the communication apparatus 1 completes the output of the data D1 (see time t18 of output waveform W1). The sampling points SP11 and SP12 are set within the sampling possible period SR2.

The communication apparatuses 1 and 2 are connected to the communication bus 3 and perform communication using Carrier Sense Multiple Access with Collision Avoidance (CSMA/CA). The communication apparatuses 1 and 2 transmit data to the communication bus 3, and thereafter detect an edge of data on the communication bus 3 (S30, S40). After the communication apparatuses 1 and 2 detect the edge, the number of detected edges becomes equal to or more than the sampling determination value. Thereafter, the communication apparatuses 1 and 2 obtain data from the communication bus 3 to determine a collision of data on the communication bus 3 (S50 to S100).

Since the communication apparatuses 1 and 2 described above perform communication using Carrier Sense Multiple Access with Collision Avoidance (CSMA/CA), the communication apparatuses 1 and 2 determine a collision between the data transmitted therefrom and the data transmitted from other communication apparatuses connected with the communication bus 3, for each bit of the data transmitted from the communication apparatuses 1 and 2.

Note that, in the communication apparatus 1, the timing at which the sampling is performed, i.e. the sampling point, is required to be set within a period during which transmitted data from another communication apparatus (i.e. the communication apparatus 2) connected with the communication bus 3 arrives at the communication apparatus 1 via the communication bus 3 and the communication apparatus 1 transmits data.

For this reason, in a state where the communication apparatus 2 transmits data before the data transmitted from the communication apparatus 1 arrives at the communication apparatus 2, the sampling point is required to be set so as to be equal to or later than the latest timing at which the data transmitted from the communication apparatus 2 arrives at the communication apparatus 1 via the communication bus 3. Hereinafter, the above “the latest timing at which the data transmitted from the communication apparatus 2 arrives at the communication apparatus 1 via the communication bus 3” is referred to as “lower limit of sampling possible period”.

Furthermore, the sampling point is required to be set before the time which indicates that the communication apparatus 1 completes the transmission of data. Hereinafter, the above “the time which indicates that the communication apparatus 1 completes the transmission of data” is referred to as “upper limit of sampling possible period”.

Then, in the communication apparatus 1, the sampling point is set with reference to a basic point (hereinafter, referred to as “sampling setting basic point”) which is the time point (hereinafter also referred to as “edge detection time point”, time t9 in FIG. 3) at which the communication apparatus 1 detects an edge of data on the communication bus 3 after the communication apparatus 1 transmits data to the communication bus 3. That is, the sampling setting basic point is the time point which indicates that the communication apparatus 1 starts the transmission of data. The time point, which indicates that the communication apparatus 1 completes the transmission of data, is delayed from the sampling setting basic point by one bit (time t15 in FIG. 3).

That is, the communication apparatus 1 obtains data on the communication bus 3 after transmitting data, and detects an edge using the obtained data. Hence, the communication apparatus 1 can delay the sampling setting basic point compared with the case where the time point at which the communication apparatus 1 transmits data to the communication bus 3 is defined as the sampling setting basic point. Therefore, the sampling point can be delayed in accordance with the delay of the sampling setting basic point. In addition, the upper limit of sampling possible period can be delayed.

Therefore, in the communication apparatus 1, compared with the case where the time point at which the communication apparatus transmits data to the communication bus 3 is defined as the sampling setting basic point, the lower limit of sampling possible period is the same, and the upper limit of sampling possible period can be delayed. Therefore, the period of time (hereinafter, referred to as “sampling possible period”) during which the sampling point can be set can be extended.

In addition, the latest timing at which the communication apparatus 2 transmits data before the data transmitted from the communication apparatus 1 arrives at the communication apparatus 2 is immediately before the time at which the communication apparatus 2 recognizes that the data transmitted from the communication apparatus 1 arrives at the communication apparatus 2. Therefore, in this condition, the difference between the sampling point of the communication apparatus 2 and the sampling point of the communication apparatus 1 (hereinafter, referred to as “two apparatuses sampling point difference”) is maximized.

In the communication apparatus 1, compared with the case where the time point at which the communication apparatus transmits data to the communication bus 3 is defined as the sampling setting basic point, the sampling setting basic point can be delayed. Therefore, the maximum value of the two apparatuses sampling point difference can be smaller.

As described above, the sampling possible period can be extended. Furthermore, the maximum value of the two apparatuses sampling point difference can be smaller. Therefore, even when the sampling possible period becomes shorter as the time period for one bit becomes shorter, both the sampling points of the communication apparatuses 1 and 2 can be easily set within the sampling possible period, compared with the case where the time point at which data is transmitted to the communication bus 3 is defined as the sampling setting basic point.

Consequently, according to the communication apparatuses 1 and 2, compared with the case where the time point at which data is transmitted to the communication bus 3 is defined as the sampling setting basic point, the time period for one bit of transmitted data can be shortened without decreasing the reliability of detecting the collision, thereby providing high-speed data communication.

In the embodiment described above, steps S30 and S40 correspond to an edge detection means (section), steps S50 to S100 correspond to a data obtaining means (section), and a time period during which the number of detected edges of a clock signal becomes equal to or more than the sampling determination value corresponds to a predetermined delay time period.

It will be appreciated that the present invention is not limited to the configurations described above, but any and all modifications, variations or equivalents, which may occur to those who are skilled in the art, should be considered to fall within the scope of the present invention.

In the above embodiment, the present invention is applied to the communication system configured by connecting two communication apparatuses with a communication bus. However, the present invention may be applied to a communication system configured with three or more communication apparatuses.

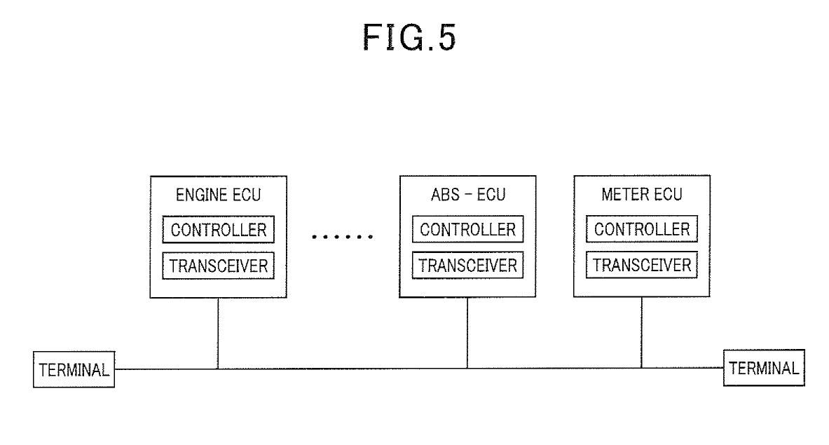

In addition, as shown in FIG. 5, vehicles incorporate a communication system in which a number of electronic control units (ECU) such as an engine ECU, an ABS-ECU, and a meter ECU are connected to a communication bus. Hence, a communication system to which the communication apparatus of the present invention is applied may be incorporated into vehicles.

Hereinafter, aspects of the above-described embodiments will be summarized.

The above embodiments provide, as one aspect, a communication apparatus which is connected with a communication bus and performs communication using Carrier Sense Multiple Access with Collision

Avoidance (CSMA/CA), including: an edge detection section which detects an edge of data on the communication bus; and a data obtaining section which obtains data from the communication bus to determine a collision of data on the communication bus after a predetermined delay time period has passed from the time at which the edge detection section detects the edge.

Since the communication apparatus described above performs communication using Carrier Sense Multiple Access with Collision Avoidance (CSMA/CA), the communication apparatus determines a collision between the data transmitted therefrom and the data transmitted from other communication apparatuses connected with the communication bus, for each bit of the data transmitted from the communication apparatus.

Note that, in the present communication apparatus, the timing at which data is obtained from the communication bus to determine a collision (hereinafter, referred to as “collision determination data obtaining timing”) is required to be set within a period during which transmitted data from another communication apparatus connected with the communication bus arrives at the present communication apparatus via the communication bus and the present communication apparatus transmits data.

For this reason, in a state where the another communication apparatus transmits data before the data transmitted from the present communication apparatus arrives at the another communication apparatus, the collision determination data obtaining timing is required to be set so as to be equal to or later than the latest timing at which the data transmitted from the another communication apparatus arrives at the present communication apparatus via the communication bus. Hereinafter, the above “the latest timing at which the data transmitted from the another communication apparatus arrives at the present communication apparatus via the communication bus” is referred to as “lower limit of data obtaining possible period”.

Furthermore, the collision determination data obtaining timing is required to be set before the time which indicates that the present communication apparatus completes the transmission of data. Hereinafter, the above “the time which indicates that the present communication apparatus completes the transmission of data” is referred to as “upper limit of data obtaining possible period”.

Then, in the present communication apparatus, the collision determination data obtaining timing is set with reference to a basic point (hereinafter, referred to as “sampling setting basic point”) which is the time point (hereinafter also referred to as “edge detection time point”) at which the present communication apparatus detects an edge of data on the communication bus after the present communication apparatus transmits data to the communication bus. That is, the sampling setting basic point is the time point which indicates that the present communication apparatus starts the transmission of data. The time point, which indicates that the present communication apparatus completes the transmission of data, is delayed from the sampling setting basic point by one bit.

That is, the present communication apparatus obtains data on the communication bus after transmitting data, and detects an edge using the obtained data. Hence, the present communication apparatus can delay the sampling setting basic point compared with the case where the time point at which the present communication apparatus transmits data to the communication bus is defined as the sampling setting basic point. Therefore, the collision determination data obtaining timing can be delayed in accordance with the delay of the sampling setting basic point. In addition, the upper limit of data obtaining possible period can be delayed.

Therefore, in the present communication apparatus, compared with the case where the time point at which the present communication apparatus transmits data to the communication bus is defined as the sampling setting basic point, the lower limit of data obtaining possible period is the same, and the upper limit of data obtaining possible period can be delayed. Therefore, the period of time (hereinafter, referred to as “data obtaining possible period”) during which the collision determination data obtaining timing can be set can be extended.

In addition, the latest timing at which the another communication apparatus transmits data before the data transmitted from the present communication apparatus arrives at the another communication apparatus is immediately before the time at which the another communication apparatus recognizes that the data transmitted from the present communication apparatus arrives at the another communication apparatus. Therefore, in this condition, the difference between the collision determination data obtaining timing of the another communication apparatus and the collision determination data obtaining timing of the present communication apparatus (hereinafter, referred to as “two apparatuses data obtaining timing difference”) is maximized.

In the present communication apparatus, compared with the case where the time point at which the present communication apparatus transmits data to the communication bus is defined as the sampling setting basic point, the sampling setting basic point can be delayed. Therefore, the maximum value of the two apparatuses data obtaining timing difference can be smaller.

As described above, the data obtaining possible period can be extended. Furthermore, the maximum value of the two apparatuses data obtaining timing difference can be smaller. Therefore, even when the data obtaining possible period becomes shorter as the time period for one bit becomes shorter, both the collision determination data obtaining timings of the present communication apparatus and the another communication apparatus can be set within the data obtaining possible period easily, compared with the case where the time point at which data is transmitted to the communication bus is defined as the sampling setting basic point.

Consequently, according to the present communication apparatus, compared with the case where the time point at which data is transmitted to the communication bus is defined as the sampling setting basic point, the time period for one bit of transmitted data can be shortened without decreasing the reliability of detecting the collision, thereby providing high-speed data communication.

In addition, vehicles incorporate a number of electronic control units connected to a communication bus. Hence, the present communication apparatus may be incorporated into vehicles.

In addition, the Controller Area Network (CAN) protocol uses Carrier Sense Multiple Access with Collision Avoidance (CSMA/CA). Hence, the frame format of a communication protocol employed in the present communication apparatus may be the frame format of the Controller Area Network (CAN) protocol.

What is claimed is:

1. A communication apparatus which is connected with a communication bus and performs communication using Carrier Sense Multiple Access with Collision Avoidance (CSMA/CA), comprising:
an edge detection section which detects an edge of data on the communication bus; and
a data obtaining section which obtains data from the communication bus to determine a collision of data on the communication bus after a predetermined delay time period has passed from the time at which the edge detection section detects the edge.

2. The apparatus according to claim 1, further comprising a clock circuit which produces a clock signal, wherein
the data obtaining section obtains data from the communication bus when the number of detected edges of the clock signal becomes equal to or more than a predetermined value.

3. The apparatus according to claim 1, wherein the apparatus is incorporated into a vehicle.

4. The apparatus according to claim 1, wherein a frame format of a communication protocol employed in the apparatus is a frame format of a Controller Area Network (CAN) protocol.
